(19) United States
(12) Patent Application Publication
(10) Pub. No.: US 2007/0061346 A1
(43) Pub. Date: Mar. 15, 2007

(54) DESTINATION INFORMATION INPUT APPARATUS

(75) Inventor: Atsushi OWARI, Minato-ku, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 11/461,022

(22) Filed: Jul. 31, 2006

(30) Foreign Application Priority Data
Aug. 1, 2005 (JP) 2005-222625

(51) Int. Cl. G06F 7/00

(52) U.S. Cl. 707/100

(57) ABSTRACT

In a destination information input apparatus, a storing unit previously stores destination information constructed by a predetermined character train, a character input unit receives the predetermined character/character train, a destination information searching unit searches for the destination information connected to the character/character train from the storing unit, an operation instruction input unit allows the detected destination information to be displayed in predetermined display order, and a destination information deciding unit obtains the selection/decision of the desired destination information from the displayed destination information. Even when a display space is small, all of the detected addresses can be selected.

### BACKGROUND OF THE INVENTION

1. Field of the Invention

The invention relates to a destination information input apparatus for inputting destination information in E-mail or the like.

2. Related Background Art

There has been opened a list displaying function of E-mail addresses for searching for the E-mail addresses from an address book, automatically displaying a list of the detected addresses, and requesting the user to select a desired address (for example, refer to JP-A-2003-16003). According to such a technique, when a plurality of E-mail addresses are designated as destinations, if a character or a character train is inputted, an E-mail address search processing unit detects E-mail addresses including the inputted character or character train as an initial or initials from an E-mail address storing unit. The detected E-mail addresses are displayed as a list to an E-mail address display processing unit. A predetermined E-mail address is selected from the list. In this instance, when a display space is sufficiently large, since all of the detected addresses are displayed as a list, all of the addresses can be selected. However, when the display space is small, since all of the detected addresses cannot be displayed as a list, the case where all of the addresses cannot be selected also occurs.

It is, therefore, a problem which cannot be solved that when the display space of the searched addresses is sufficiently large, all of the detected addresses can be selected, but when the display space is small, since all of the detected addresses cannot be displayed as a list, the case where all of the addresses cannot be selected also occurs.

### SUMMARY OF THE INVENTION

It is an object of the invention to provide a destination information input apparatus for inputting destination information in E-mail or the like.

According to the present invention, there is provided a destination information input apparatus which has a storing unit for previously storing destination information constructed by a predetermined character train, detects the destination information connected to one or more characters from the storing unit when the one or more characters are received, and displays the detected destination information onto a predetermined display unit, comprising:

an operation instruction input unit for causing the destination information detected from the storing unit to be displayed in a predetermined display order corresponding to a predetermined rule through an operation; and

a destination information deciding unit for obtaining a selection and decision of a desired destination information from the displayed destination information.

Moreover, the destination information input apparatus may further comprise a display controlling unit which makes the destination information be displayed on the predetermined display unit in a corresponding the display order when plural the predetermined rule are set to correspond to different plural the display order and the operation instruction input unit inputted a display instruction for selecting one of the predetermined rules.

Moreover, in the destination information input apparatus, when the display instruction is received from the operation instruction input unit, the display controlling unit causes a plurality of the destination information to be displayed on the predetermined display unit in the display order.

Moreover, in the destination information input apparatus, each time the display instruction is received from the operation instruction input unit, the display controlling unit updates one of the plurality of destination information to be displayed on the predetermined display unit.

Moreover, in the destination information input apparatus, he predetermined rule is alphabetical order of the destination information.

Moreover, in the destination information input apparatus, he predetermined rule is an order obtained on the basis of the number of times for selecting and deciding the destination information.

Moreover, the destination information input apparatus may further comprise a timer section which measures time when the selection and decision of the destination information is executed, and wherein the predetermined rule is an order obtained on the basis of the latest execution time of the selection and decision.

Furthermore, according to the present invention, also there is provided a destination information input apparatus which has a storing unit in which a number of destination information each constructed by a character train has been stored, a searching unit for searching for a plurality of the destination information each including an inputted character from the storing unit, and a display unit for displaying part by part the plurality of searched destination information, comprising:

a display controlling unit which sets the display order of the plurality of searched destination information on the basis of the predetermined rule; and

a destination information deciding unit which selects and decides any one of the destination information displayed on the display unit,

wherein the display controlling unit makes the remaining destination information be displayed on the display unit except the selected and decided destination information on the basis of the display order.

Since the apparatus has the operation instruction input unit which displays the destination information detected from the storing section in accordance with the predetermined display order and the destination information deciding unit which obtains the selection decision of the desired destination information from the displayed destination information, such an effect that even if the display space is small, all of the detected “destination information” can be selected is obtained.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a construction of an embodiment 1;

FIG. 2 is an external view of an operation panel;

FIG. 3 is an explanatory diagram of a storing state of destination information;

FIG. 4 is an operation flowchart of the invention;

FIG. 5 is a display transition diagram of selection and decision of the destination information in the embodiment 1;

FIG. 6 is a block diagram showing a construction of an embodiment 2; and

FIG. 7 is a display transition diagram of selection and decision of destination information in the embodiment 2.

### DETAILED DESCRIPTION OF THE PREFERRED EMBODIMENTS

A destination information input apparatus according to the invention is realized only by changing a control program of a conventional destination information input apparatus.

### Embodiment 1

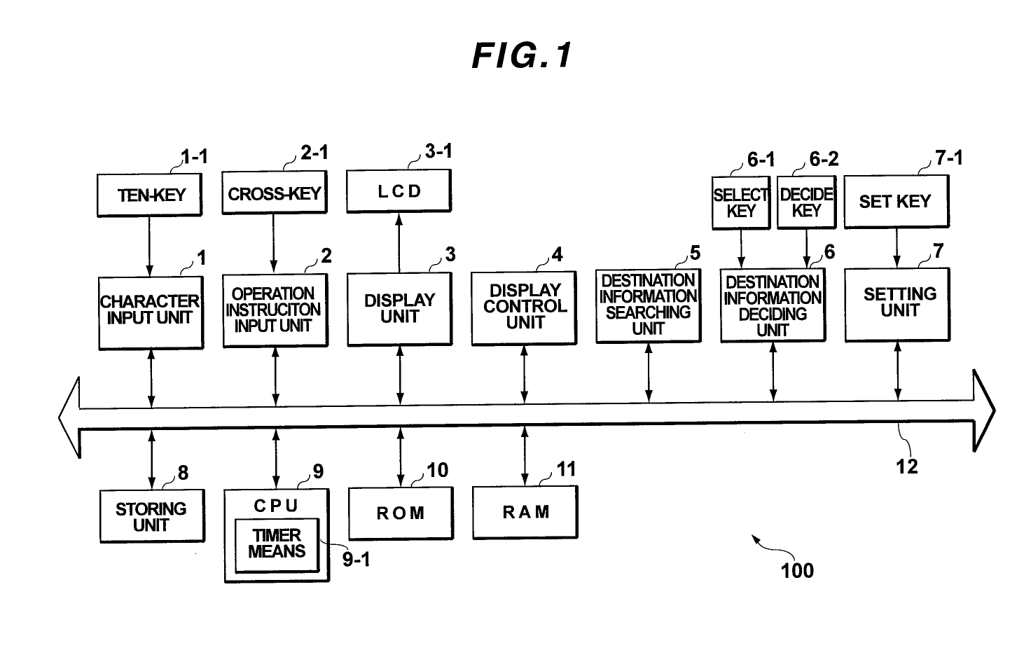

FIG. 1 is a block diagram showing a construction of an embodiment 1.

As shown in the diagram, a destination information input apparatus 100 of the embodiment 1 has: a character input unit 1; an operation instruction input unit 2; a display unit 3; a display controlling unit 4; a destination information searching unit 5; a destination information deciding unit 6; a setting unit 7; a storing unit 8; a CPU 9; a ROM 10; a RAM 11; and a common bus 12.

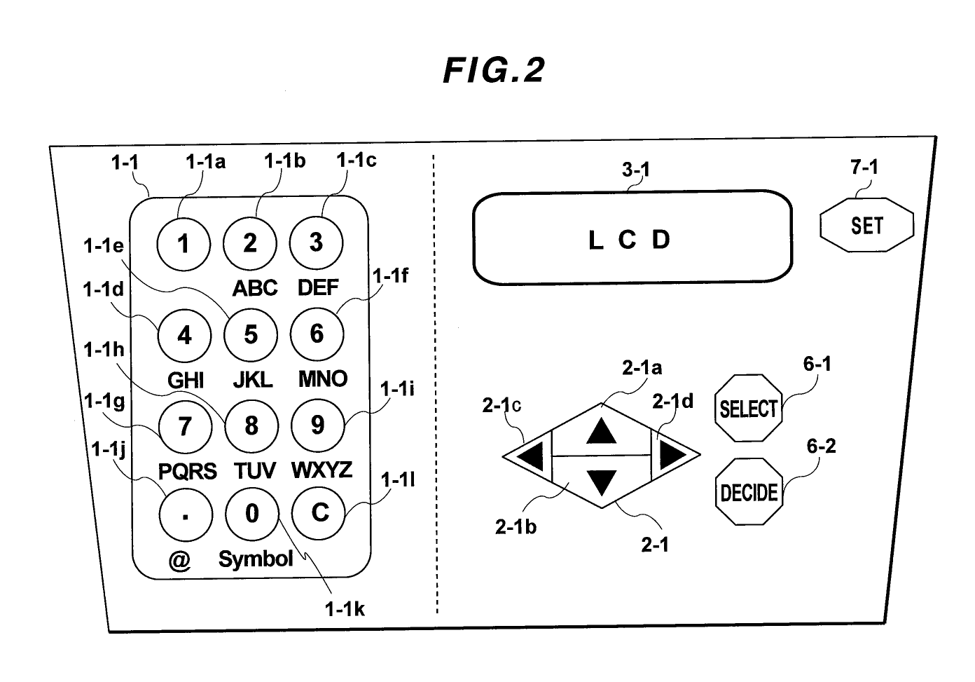

FIG. 2 is an external view of an operation panel.

This diagram is a diagram showing layout positions on the operation panel of various keys which are necessary in explanation of FIG. 1. Reference numeral 1-1 denotes a ten-key; 2-1 a cross-key; 3-1 an LCD; 6-1 a select key; 6-2 a decide key; and 7-1 a set key.

The construction of the destination information input apparatus 100 of the embodiment 1 will be described in detail with reference to FIGS. 1 and 2.

The character input unit 1 is a portion which receives a character input from the user through the ten-key 1-1. A character or a character train connected to an E-mail address (destination information) is inputted from this portion by the user. An example of a relation between the ten-key 1-1 and the character which is inputted is shown.

Character codes or the like corresponding to the input keys have been stored in the ROM or the like. The CPU fetches the character code or the like corresponding to the key and supplies it to the display controlling unit 4.

An example of allocation of each key to the character is shown below.

When a ten-key 1-1a is pressed once, “1” is inputted. When a ten-key 1-1b is pressed once, “2” is inputted. When the ten-key 1-1b is continuously pressed twice, “a” is inputted. When it is continuously pressed thrice, “b” is inputted. After that, each time the number of pressing times of the ten-key 1-1b is increased by 1, “c”, “A”, “B”, or “C” is inputted in order. When a ten-key 1-1c is pressed once, “3” is inputted. When the ten-key 1-1c is continuously pressed twice, “d” is inputted. When it is continuously pressed thrice, “e” is inputted. After that, each time the number of pressing times of the ten-key 1-1c is increased by 1, “f”, “D”, “E”, or “F” is inputted in order.

When a ten-key 1-1d is pressed once, “4” is inputted. When the ten-key 1-1d is continuously pressed twice, “g” is inputted. When it is continuously pressed thrice, “h” is inputted. After that, each time the number of pressing times of the ten-key 1-1d is increased by 1, “i”, “G”, “H”, or “I” is inputted in order. When a ten-key 1-1e is pressed once, “5” is inputted. When the ten-key 1-1e is continuously pressed twice, “j” is inputted. When it is continuously pressed thrice, “k” is inputted. After that, each time the number of pressing times of the ten-key 1-1e is increased by 1, “1”, “K”, or “L” is inputted in order.

When a ten-key 1-1f is pressed once, “6” is inputted. When the ten-key 1-1f is continuously pressed twice, “m” is inputted. When it is continuously pressed thrice, “n” is inputted. After that, each time the number of pressing times of the ten-key 1-1f is increased by 1, “o”, “M”, “N”, or “O” is inputted in order. When a ten-key 1-1g is pressed once, “7” is inputted. When the ten-key 1-1g is continuously pressed twice, “p” is inputted. When it is continuously pressed thrice, “q” is inputted. After that, each time the number of pressing times of the ten-key 1-1g is increased by 1, “r”, “s”, “P”, “Q”, “R”, or “S” is inputted in order.

When a ten-key 1-1h is pressed once, “8” is inputted. When the ten-key 1-1h is continuously pressed twice, “t” is inputted. When it is continuously pressed thrice, “u” is inputted. After that, each time the number of pressing times of the ten-key 1-1h is increased by 1, “v”, “T”, “U”, or “V” is inputted in order. When a ten-key 1-1i is pressed once, “9” is inputted. When the ten-key 1-1i is continuously pressed twice, “w” is inputted. When it is continuously pressed thrice, “x” is inputted. After that, each time the number of pressing times of the ten-key 1-1i is increased by 1, “y”, “z”, “W”, “X”, “Y”, or “Z” is inputted in order.

When a ten-key 1-1j is pressed once, “.” is inputted. When the ten-key 1-1j is continuously pressed twice, “,” is inputted. After that, each time the number of pressing times of the ten-key 1-1j is increased by 1, “@” is inputted. When a ten-key 1-1k is pressed once, “0” is inputted. When the ten-key 1-1k is continuously pressed twice, “ ” is inputted. When it is continuously pressed thrice, “/” is inputted. After that, each time the number of pressing times of the ten-key 1-1k is increased by 1, “:”, “-”, “;”, “,”, “*”, “+”, “=”, “_”, “?”, “!”, “″”, “#”, “$”, “%”, “&”, “′”, “ˆ”, “<”, or “>” is inputted in order. When a ten-key 1-1l is pressed once, the inputted character is deleted.

The operation instruction input unit 2 is a portion which instructs the display controlling unit 4 to read out the E-mail addresses one by one from the storing unit 8 and transfer it to the LCD 3-1. This instruction is executed by a request from the user through the cross-key 2-1. The operation instruction input unit 2 is also a portion which instructs and inputs a predetermined rule to decide display order of the E-mail addresses which are read out of the storing unit 8 by the display controlling unit 4 and transferred to the LCD 3-1 one by one by the user through the cross-key 2-1. The operation instruction input unit 2 is also a portion which instructs the display controlling unit 4 to scroll display addresses of the LCD 3-1.

The display unit 3 has the LCD 3-1 and is a portion which allows the display controlling unit 4 to supply one by one the E-mail addresses which are read out of a predetermined area in the storing unit 8 on the basis of the instruction of the operation instruction input unit 2 and allows the LCD 3-1 to display each E-mail address. Generally, a liquid crystal display panel may be used as an LCD 3-1.

The display controlling unit 4 is a portion which reads out the E-mail addresses which have been detected by the destination information searching unit 5 and stored from a temporary area in the storing unit 8 and allows them to be held in the temporary area in the storing unit 8 in display order based on the predetermined rule. The display controlling unit 4 is a portion which reads out the E-mail addresses one by one from the temporary area in the storing unit 8 and transfers them to the display unit 3 in response to a transfer request from the user through the operation instruction input unit 2. As an example of the predetermined rule of the display order of the E-mail addresses, alphabetical order, order from the latest destination decision time, order from the larger number of destination deciding times, or the like can be mentioned. The predetermined rule is inputted from the operation instruction input unit 2 through the cross-key 2-1 by the user. When the set key 7-1 is pressed by the user, the setting unit 7 sets the inputted predetermined rule.

The destination information searching unit 5 which searches the storing unit 8 when the predetermined character or character train inputted by the user through the character input unit 1 is received, searches for the E-mail addresses connected to the character or character train, and allows them to be temporarily held in the temporary area in the storing unit 8. For example, when the user inputs the alphabet “b” by pressing the ten-key 1-1 thrice, for example, the E-mail addresses connected to “b” such as “baaxyz@sss.co.jp”, “bpflmn@ttt.com”, “bzzccb@abc.co.jp”, and the like are detected and temporarily held in the temporary area in the storing unit 8.

The destination information deciding unit 6 has the select key 6-1 and the decide key 6-2 and is a portion which allows the user to select a desired E-mail address through the select key 6-1 from the E-mail addresses displayed in the display unit 3 in accordance with the predetermined display order and to decide it through the decide key 6-2.

The setting unit 7 has the set key 7-1 and is a portion which sets the predetermined rule (rule to set the display order of the E-mail addresses) inputted by the user from the operation instruction input unit 2 through the cross-key 2-1 when the set key 7-1 is pressed by the user.

The storing unit 8 is a memory having: a non-volatile memory area for previously storing the E-mail address constructed by the predetermined character train; and the temporary area in which the E-mail addresses detected by the destination information searching unit 5 are temporarily held and, further, the display controlling unit 4 changes the display order of the E-mail addresses in accordance with the predetermined rule and stores them again. Generally, a part of the memory area in the RAM 11 is used as a temporary area. An example of the state where the E-mail addresses have been stored in the storing unit 8 at the preceding time will now be described.

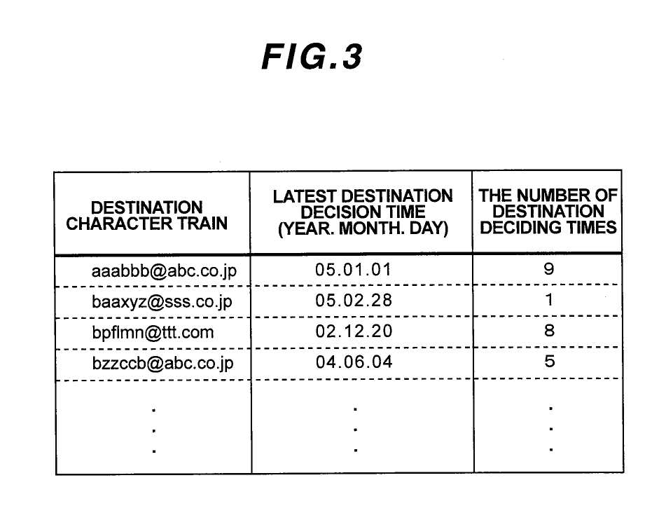

FIG. 3 is an explanatory diagram of the storing state of the destination information.

As shown in the diagram, the destination character train (E-mail address), the latest destination decision time, and the number of deciding times have been stored in association with each other.

The CPU 9 is a microprocessor for controlling the whole apparatus by executing a control program which has previously been stored in the ROM 10. In the embodiment, the CPU 9 activates the display controlling unit 4 and the destination information searching unit 5 by executing, particularly, the predetermined control program which has previously been stored in the ROM 10. Further, the CPU 9 has therein the timer section 9-1 which measures the destination decision time.

The ROM 10 is a read only memory in which a control program for the CPU 9 to control the whole apparatus by executing it has previously been stored. Particularly, in the embodiment, the control program for the CPU 9 to activate the display controlling unit 4 and the destination information searching unit 5 by executing it has previously been stored in the ROM 10.

The RAM 11 is a random access memory which provides an arithmetic operating area which is necessary when the CPU 9 executes the predetermined control program. Particularly, in the embodiment, the RAM 11 is a portion which provides the temporary area in the storing unit 8.

The common bus 12 is a signal line connecting each of the foregoing portions.

The operation of the embodiment 2 will be described.

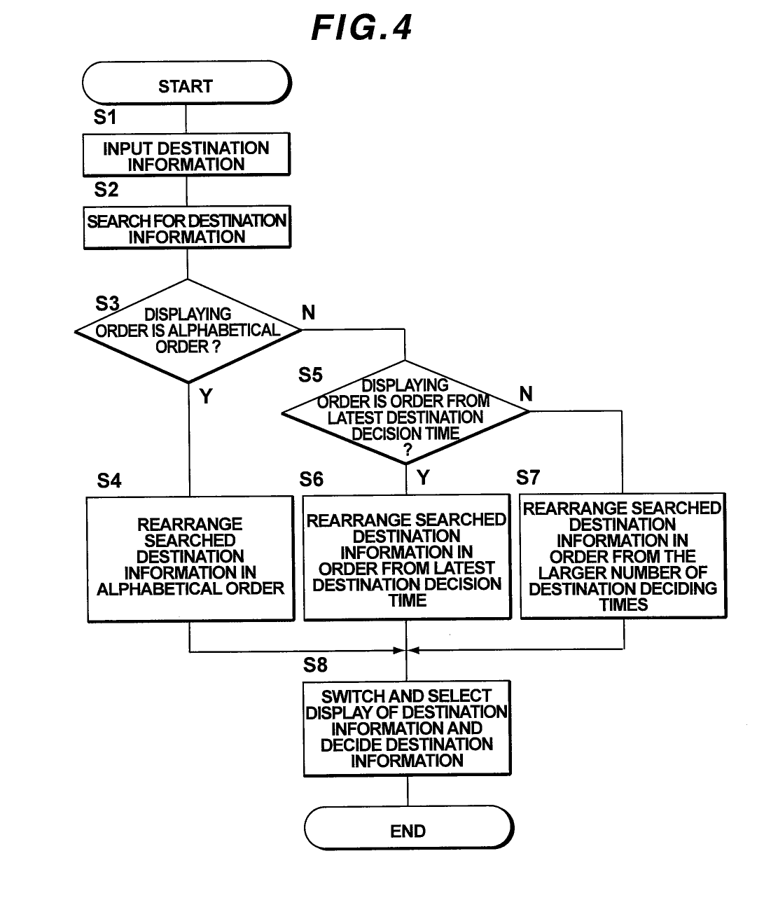

FIG. 4 is an operation flowchart of the invention.

The operation of the destination information input apparatus 100 (FIG. 1) of the embodiment 1 will be described in step order of steps S1 to S8 in the flowchart.

As prerequisite conditions for the explanation of the operation, it is now assumed that the destination information (E-mail addresses) has been stored in the storing unit 8 (FIG. 1) in the state where it is associated with the latest destination decision time and the number of deciding times have been stored as shown in FIG. 3.

Step S1:

The user inputs the initial of the destination information by operating the ten-key 1-1 (FIG. 2). For example, he presses the ten-key 1-1b (FIG. 2) thrice. The initial “b” of the destination information inputted at this time is displayed on the LCD 3-1 (FIG. 1).

Step S2:

When the user presses a cross-key 2-1b (FIG. 2), the destination information searching unit 5 (FIG. 1) searches for the destination information (FIG. 3) stored in the storing unit 8 (FIG. 1), detects the E-mail addresses connected to the initial “b”, and allows them to be temporarily held in the temporary area in the storing unit 8 (FIG. 1). By the prerequisite conditions, “baaxyz@sss.co.jp”, “bpflmn@ttt.com”, and “bzzccb@abc.co.jp” are detected and temporarily held in the temporary area in the storing unit 8 (FIG. 1). The key to allow the destination information searching unit 5 (FIG. 1) to start the search of the storing unit 8 (FIG. 1) is not limited to the cross-key 2-1b (FIG. 2) but may be a cross-key 2-1a, a cross-key 2-1c, or a cross-key 2-1d.

Step S3:

If the predetermined rule to decide the display order has been set to the alphabetical order, the processing routine advances to step S4. In other cases, step S5 follows.

Step S4:

The display controlling unit 4 (FIG. 1) changes the display order of the E-mail addresses detected by the destination information searching unit 5 (FIG. 1) to the alphabetical order and allows the E-mail addresses to be temporarily held again in the temporary area in the storing unit 8 (FIG. 1). The E-mail addresses are stored in order of “baaxyz@sss.co.jp”, “bpflmn@ttt.com”, and “bzzccb@abc.co.jp” here.

Step S5:

If the predetermined rule to decide the display order has been set to the order from the latest destination decision time, step S6 follows. If it has been set to the other order (order from the larger number of destination deciding times), step S7 follows.

Step S6:

The display controlling unit 4 (FIG. 1) changes the display order of the E-mail addresses detected by the destination information searching unit 5 (FIG. 1) to the order from the latest destination decision time and allows the E-mail addresses to be temporarily held again in the temporary area in the storing unit 8 (FIG. 1). On the basis of the latest destination decision time in FIG. 3, the E-mail addresses are stored in order of “baaxyz@sss.co.jp”, “bzzccb@abc.co.jp”, and “bpflmn@ttt.com” here.

Step S7:

The display controlling unit 4 (FIG. 1) changes the display order of the E-mail addresses detected by the destination information searching unit 5 (FIG. 1) to the order from the larger number of destination deciding times and allows the E-mail addresses to be temporarily held again in the temporary area in the storing unit 8 (FIG. 1). If the numbers of deciding times are equal, the E-mail addresses are arranged in the alphabetical order. On the basis of the numbers of deciding times in FIG. 3, the E-mail addresses are stored in order of “bpflmn@ttt.com”, “bzzccb@abc.co.jp”, and “baaxyz@sss.co.jp”, here.

Step S8:

The user presses the cross-key 2-1 (FIG. 1), switches the display of the destination information (E-mail addresses), selects the destination information, decides the selected destination information, and finishes the processing flow. Details of the operation in this instance will now be described.

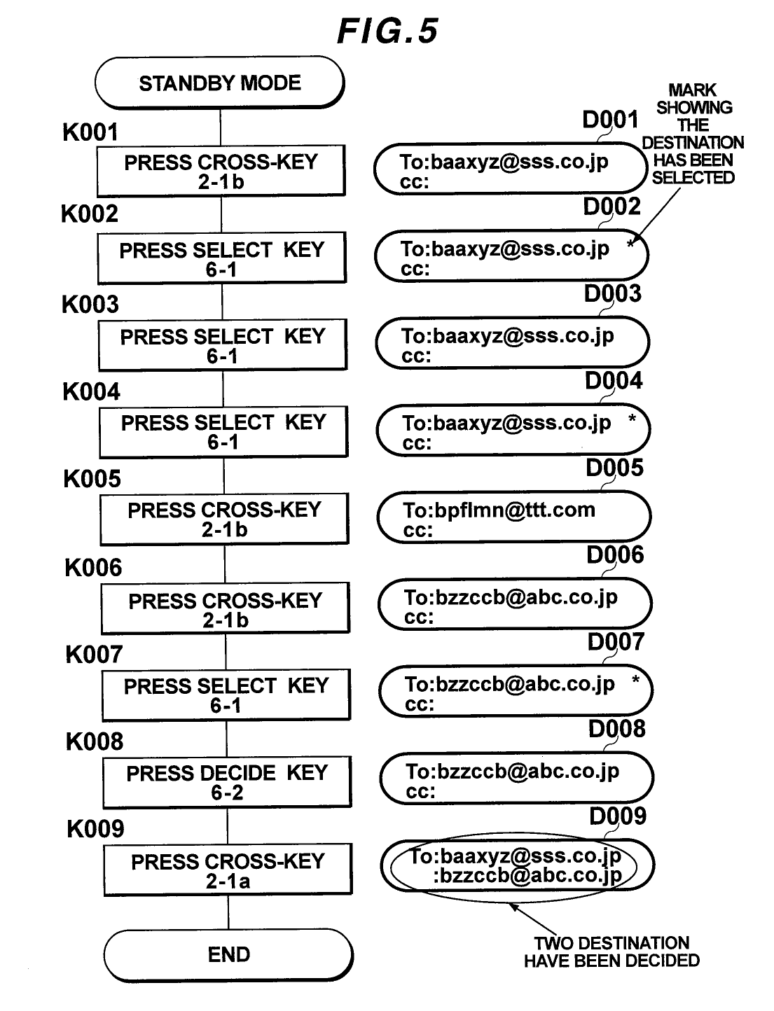

FIG. 5 is a display transition diagram of the selection and decision of the destination information in the embodiment 1.

The key operation which is executed by the user until the display switching, selection, and decision of the destination information are performed will be described in step order of steps K001 to K009 with reference to this diagram. As prerequisite conditions for the explanation of the operation, it is now assumed that this flow has passed through step S4 mentioned above. That is, it is assumed that the display order of the E-mail addresses detected by the destination information searching unit 5 (FIG. 1) is changed to the alphabetical order by the display controlling unit 4 (FIG. 1) and the E-mail addresses have been stored in the temporary area in the storing unit 8 (FIG. 1) in order of “baaxyz@sss.co.jp”, “bpflmn@tttt.com”, and “bzzccb@abc.co.jp”.

Step K001:

When the user presses the cross-key 2-1b (FIG. 2), “baaxyz@sss.co.jp” which has been first stored in the temporary area in the storing unit 8 (FIG. 1) is displayed on the LCD 3-1 (FIG. 2) (D001).

Step K002:

When the user presses the select key 6-1 (FIG. 2), * is added to the end of “baaxyz@sss.co.jp” (D002). To the user, this section that it has been selected as destination information.

Step K003:

When the user presses the select key 6-1 (FIG. 2) again, * is deleted from the end of “baaxyz@sss.co.jp” (D003). To the user, this section that the selection as destination information has been cancelled.

Step K004:

When the user further presses the select key 6-1 (FIG. 2) again, * is added to the end of “baaxyz@sss.co.jp” (D004).

The operations of steps K002 to K004 mentioned above denote that the selection and the cancellation are repeated each time the user presses the select key 6-1 (FIG. 2). Although the selection and the cancellation have been repeated here, “baaxyz@sss.co.jp” has finally been selected.

Step K005:

When the user presses the cross-key 2-1b (FIG. 2), “bpflmn@ttt.com” stored in the second area in the temporary area in the storing unit 8 (FIG. 1) is displayed in the LCD 3-1 (FIG. 2) (D005).

Step K006:

When the user presses the cross-key 2-1b (FIG. 2), “bzzccb@abc.co.jp” stored in the third area in the temporary area in the storing unit 8 (FIG. 1) is displayed in the LCD 3-1 (FIG. 2) (D006). In this instance, the selection is omitted with respect to “bpflmn@ttt.com” stored in the second area in the temporary area and “bzzccb@abc.co.jp” stored in the third area in the temporary area is examined here.

Step K007:

When the user presses the select key 6-1 (FIG. 2), * is added to the end of “bzzccb@abc.co.jp” (D007). In this instance, “bzzccb@abc.co.jp” stored in the third area in the temporary area has been selected by the user.

Step K008:

When the user presses the decide key 6-2 (FIG. 2), the selected “baaxyz@sss.co.jp” and “bzzccb@abc.co.jp” are collectively decided as destinations. In this case, * is deleted from the end of “bzzccb@abc.co.jp” (D008).

Step K009:

When the user presses the cross-key 2-1a (FIG. 2), the decided destinations “baaxyz@sss.co.jp” and “bzzccb@abc.co.jp” can be confirmed.

The embodiment has been described here with respect to the case where the display order of the E-mail addresses detected by the destination information searching unit 5 (FIG. 1) is changed to the alphabetical order by the display controlling unit 4 (FIG. 1) and the E-mail addresses have been held in the temporary area in the storing unit 8 (FIG. 1). Since substantially the same processes are also executed in the case where the display order is changed to the order from the latest destination decision time or the order from the larger number of destination deciding times, their description is omitted here.

As described above, according to the embodiment, since the apparatus has the operation instruction input unit 2 (FIG. 1) for allowing the destination information detected from the storing unit (FIG. 1) to be displayed in the predetermined display order and the destination information searching unit 5 (FIG. 1) for obtaining the selection and decision of the desired destination information from the displayed destination information, such an effect that even if the display space is small, all of the detected addresses can be selected is obtained.

### Embodiment 2

Although the embodiment 1 has been described on the assumption that the E-mail addresses are displayed one by one in the LCD 3-1 (FIG. 1) when requesting the user to select the destination information, it is assumed that a plurality of E-mail addresses are displayed at a time in the embodiment 2.

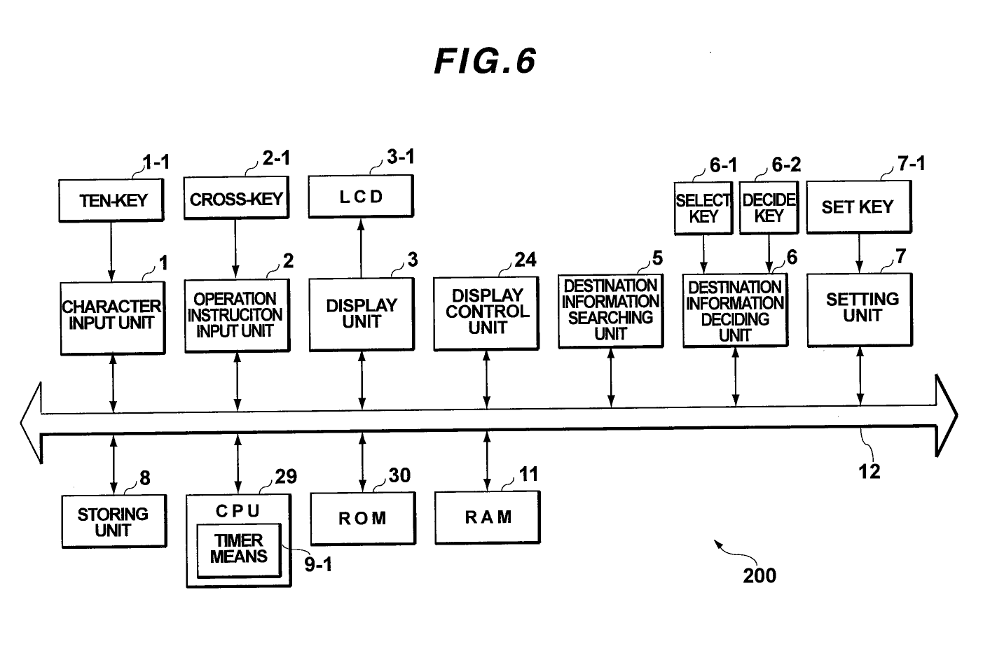

FIG. 6 is a block diagram showing a construction of the embodiment 2.

As shown in the diagram, a destination information input apparatus 200 of the embodiment 2 has: the character input unit 1; the operation instruction input unit 2; the display unit 3; a display controlling unit 24; the destination information searching unit 5; the destination information deciding unit 6; the setting unit 7; the storing unit 8; a CPU 29; a ROM 30; the RAM 11; and the common bus 12. Only the portions different from those in the embodiment 1 will be described hereinbelow and the portions similar to those in the embodiment 1 are designated by the same reference numerals as those in the embodiment 1 and their explanation is omitted here.

The display controlling unit 24 is a portion which reads out the E-mail addresses detected by the destination information searching unit 5 from the temporary area in the storing unit 8, changes the display order in accordance with the predetermined rule, and allows them to be held in the temporary area in the storing unit 8 again. The display controlling unit 24 is also a portion which reads out the E-mail addresses two by two from the temporary area in the storing unit 8 in the display order and transfers them to the display unit 3 in response to the request from the user through the operation instruction input unit 2. However, the display order 1 and 2 are displayed in the first display, the display order 2 and 3 are displayed in the next (second) display, and the display order 3 and 4 are displayed in the third display. That is, it is assumed that one E-mail address which has previously been transferred is included in the two E-mail addresses. As an example of the predetermined rule of the display order of the E-mail addresses, the alphabetical order, the order from the latest destination decision time, the order from the larger number of destination deciding times, or the like can be mentioned. The predetermined rule is inputted from the operation instruction input unit 2 through the cross-key 2-1 by the user. When the set key 7-1 is further pressed by the user, the setting unit 7 sets the predetermined rule.

The CPU 29 is a microprocessor for controlling the whole apparatus by executing a control program which has previously been stored in the ROM 30. In the embodiment, the CPU 29 activates the display controlling unit 24 and the destination information searching unit 5 by executing, particularly, the predetermined control program which has previously been stored in the ROM 30. Further, the CPU 29 has therein the timer section 9-1 which measures the destination decision time.

The ROM 30 is a read only memory in which the control program for the CPU 29 to control the whole apparatus by executing it has previously been stored. Particularly, in the embodiment, the control program for the CPU 29 to activate the display controlling unit 24 and the destination information searching unit 5 by executing has previously been stored in the ROM 30.

The operation of the embodiment 2 will be described. The operation different from that of the embodiment 1 is only the operation to select and decide the destination information (FIG. 5) and other operation is similar to that in the embodiment 1. Therefore, only the operation to select and decide the destination information will be described.

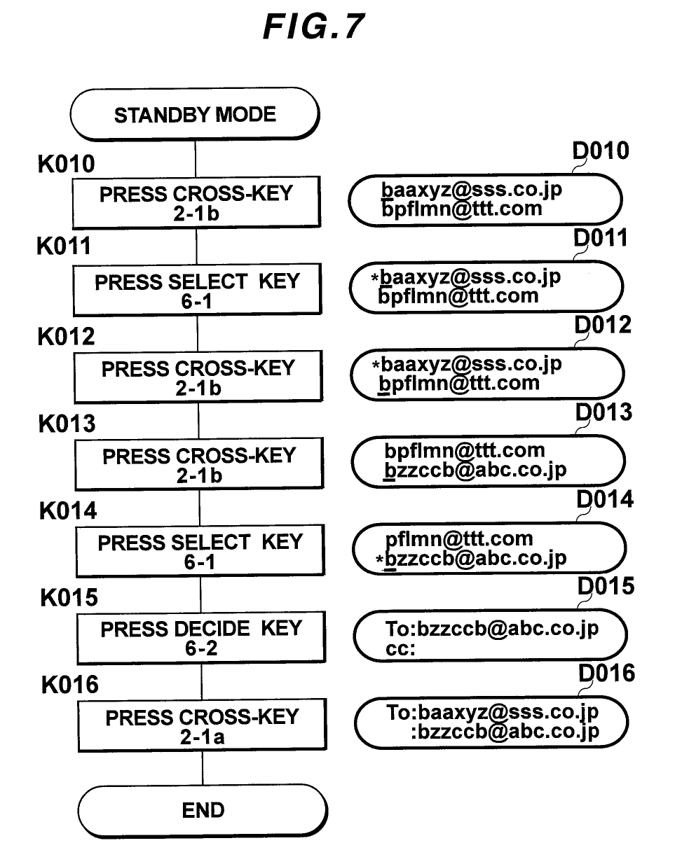

FIG. 7 is a display transition diagram of the selection and decision of the destination information in the embodiment 2.

The key operation which is executed by the user until the display switching, selection, and decision of the destination information are performed will be described in step order of steps K010 to K016 with reference to this diagram. As prerequisite conditions for the explanation of the operation, it is now assumed that this flow has passed through step S4 mentioned above. That is, it is assumed that the display order of the E-mail addresses detected by the destination information searching unit 5 (FIG. 6) is changed to the alphabetical order by the display controlling unit 24 (FIG. 6) and the E-mail addresses have been stored in the temporary area in the storing unit 8 (FIG. 6) in order of “baaxyz@sss.co.jp”, “bpflmn@ttt.com”, and “bzzccb@abc.co.jp”.

Step K010:

When the user presses the cross-key 2-1b (FIG. 2), “baaxyz@sss.co.jp” which has been first stored in the temporary area in the storing unit 8 (FIG. 6) and “bpflmn@ttt.com” stored in the second area are displayed together on the LCD 3-1 (FIG. 2) (D010). At this time, a cursor is displayed under the initial of “baaxyz@sss.co.ip”.

Step K011:

When the user presses the select key 6-1 (FIG. 2), * is added to the head of “baaxyz@sss.co.jp” where the cursor has been displayed (D011).

Step K012:

When the user presses the cross-key 2-1b (FIG. 2), the cursor is moved downward by one row. That is, the cursor is displayed under the initial of “bpflmn@ttt.com” (D012).

Step K013:

When the user presses the cross-key 2-1b (FIG. 2) again, “baaxyz@sss.co.jp” displayed in the first row at present is erased and “bpflmn@ttt.com” is displayed in the first row. Further, “bzzccb@abc.co.jp” stored in the third area in the temporary area in the storing unit 8 (FIG. 6) is displayed in the second row and the cursor is moved under the initial of “bzzccb@abc.co.jp” (D013).

Step K014

When the user presses the select key 6-1 (FIG. 2), * is added to the head of “bzzccb@abc.co.jp” (D014) where the cursor has been displayed (D014).

Step K015:

When the user presses the decide key 6-2 (FIG. 2), the selected “baaxyz@sss.co.jp” and “bzzccb@abc.co.jp” are collectively decided as destinations. In this case, * is deleted from the head of “bzzccb@abc.co.jp” (D015).

Step K016:

When the user presses the cross-key 2-1a (FIG. 2), the decided destinations “baaxyz@sss.co.jp” and “bzzccb@abc.co.jp” can be confirmed.

The embodiment 1 has been described above on the assumption that the E-mail addresses are displayed one by one onto the LCD 3-1 (FIG. 1) when requesting the user to select the destination information. However, in the embodiment 2, a plurality of E-mail addresses are simultaneously displayed. Therefore, in addition to the effect of the embodiment 1, such an effect that the processing time necessary to select and decide the destination information can be shortened is obtained.

Although the embodiment has been described above by limiting the destination information which is displayed onto the LCD 3-1 (FIG. 6) to two rows, the invention is not limited to such an example. That is, it may be set to three or more rows.

The destination information input apparatus according to the invention described above can be applied not only to the printer but also to a facsimile apparatus, a copying apparatus, a scanner apparatus, a copying apparatus, a multi-function apparatus, or the like.

It should be understood by those skilled in the art that various modifications, combinations, sub-combinations and alterations may occur depending on design requirements and other factors insofar as they are within the scope of the appended claims or the equivalents thereof.

What is claimed is:

1. A destination information input apparatus which has a storing unit for previously storing destination information constructed by a predetermined character train, detects the destination information connected to one or more characters from said storing unit when said one or more characters are received, and displays the detected destination information onto a predetermined display unit, comprising:
an operation instruction input unit for causing said destination information detected from said storing unit to be displayed in a predetermined display order corresponding to a predetermined rule through an operation; and
a destination information deciding unit for obtaining a selection and decision of a desired destination information from said displayed destination information.

2. The destination information input apparatus according to claim 1, further comprising a display controlling unit which makes said destination information be displayed on said predetermined display unit in a corresponding said display order when plural said predetermined rule are set to correspond to different plural said display order and said operation instruction input unit inputted a display instruction for selecting one of said predetermined rules.

3. The destination information input apparatus according to claim 2, wherein when the display instruction is received from said operation instruction input unit, said display controlling unit causes a plurality of said destination information to be displayed on said predetermined display unit in said display order.

4. The destination information input apparatus according to claim 3, wherein each time the display instruction is received from said operation instruction input unit, said display controlling unit updates one of said plurality of destination information to be displayed on said predetermined display unit.

5. The destination information input apparatus according to claim 1, wherein said predetermined rule is alphabetical order of said destination information.

6. The destination information input apparatus according to claim 1, wherein said predetermined rule is an order obtained on the basis of the number of times for selecting and deciding said destination information.

7. The destination information input apparatus according to claim 1, further comprising timer section which measures time when the selection and decision of said destination information is executed, and
wherein said predetermined rule is an order obtained on the basis of the latest execution time of the selection and decision.

8. A destination information input apparatus which has a storing unit in which a number of destination information each constructed by a character train has been stored, a searching unit for searching for a plurality of said destination information each including an inputted character from said storing unit, and a display unit for displaying part by part the plurality of searched destination information, comprising:
a display controlling unit which sets the display order of said plurality of searched destination information on the basis of a predetermined rule; and
a destination information deciding unit which selects and decides any one of the destination information displayed on said display unit,
wherein said display controlling unit makes the remaining destination information be displayed on said display unit except said selected and decided destination information on the basis of said display order.
